(19) United States
(12) Patent Application Publication
(10) Pub. No.: US 2009/0238082 A1
(43) Pub. Date: Sep. 24, 2009

(54) TELECOMMUNICATION SYSTEM COMPRISING AN O&M (Operation and Maintenance) HIERARCHICAL LAYER STRUCTURE

(76) Inventors: Harri Hakala, Turku (FI); Hans Ahlback, Turku (FI)

Correspondence Address: ERICSSON INC., 6300 LEGACY DRIVE, M/S EVR 1-C-11, PLANO, TX, 75024, US

(21) Appl. No.: 12/306,814

(22) PCT Filed: Jul. 3, 2006
(86) PCT No.: PCT/EP06/06439

§ 371 Date: Dec. 29, 2008

(51) Int. Cl. H04L 12/26

(52) U.S. Cl. 370/241.1

(57) ABSTRACT

A telecommunication system comprising an O&M (Operation and Maintenance) hierarchical layer structure comprising at least two O&M nodes in at least two hierarchical layers, where O&M actions may be initiated at said nodes. The system is arranged for generation of an O&M transaction identifier when an O&M action is initiated, and is transferred to all nodes in all management layers used for said O&M action, which is initiated inside an O&M session, allowing O&M actions and sessions to be tracked in the O&M hierarchical layer structure. The present invention also relates to a method for tracking O&M actions in an O&M hierarchical layer structure.

### TECHNICAL FIELD

The present invention relates to a telecommunication system comprising an O&M (Operation and Maintenance) hierarchical layer structure comprising at least two O&M nodes in at least two hierarchical layers, where O&M actions may be initiated at said nodes.

The present invention also relates to a method for tracking O&M (Operation and Maintenance) actions in an O&M hierarchical layer structure.

### BACKGROUND

In a modern telecommunication system, for example a 3GPP based mobile telecommunication system such as WCDMA (Wide Code Division Mutliple Access), there is usually a management system, which normally has an architecture where the management system is divided into a number of separate layers. In these layers, O&M (Operation and Maintenance) is performed. O&M management functions generally cover all tasks and functions performed by a network operator for administering and monitoring their network, for example network elements, routers and switches. Examples of these functions are activities related to fault management, performance management, configuration management etc.

As O&M systems are getting more complex, being able to serve larger and larger networks, it is very important that all user activities are logged properly, since it is necessary to keep track of who did what and when across all nodes. This kind of information is needed in order to be able to ensure that relevant information regarding the performed O&M actions are available, to be used for example when analysing fault situations afterwards.

When there are O&M management systems in different layers, having different O&M applications running in these layers, many applications produce their own log files for accountability purposes. Then, it becomes very difficult to correlate the information related to those tasks which are performed by an O&M user within one O&M session. This kind of correlation is needed, and in some cases even required by network operators, in order to be able to trace individual user activities throughout a complete O&M system.

Today, the correlation is mainly done by analysing a number of parameters, for example user id's, and time stamps which are available in corresponding logs. In some cases it will even be impossible to perform a correlation at all, since the user id's in those cases are not transferred from one layer or application to another.

There is thus a need for a system, and a method, for easy tracing and correlation of O&M user activities, because vital information such as user id, time stamps for performed O&M actions is very often missing from the logs.

### SUMMARY

The aim of the present invention to disclose a system, and a method, for easy tracing and correlation of O&M user activities.

This aim is achieved by means of a telecommunication system according to the introduction, where furthermore the system is arranged for generation of an O&M transaction identifier, which O&M transaction identifier is generated when an O&M action is initiated, and is transferred to all nodes in all management layers used for said O&M action, said O&M action being initiated inside an O&M session, allowing O&M actions and sessions to be tracked in the O&M hierarchical layer structure.

In a preferred embodiment, the hierarchical layers comprise a network management layer, a sub network management layer and an element management layer, the layers forming an O&M hierarchical layer structure.

In another preferred embodiment, any node where an O&M action is initiated, is arranged to generate an O&M transaction identifier and, when needed, to transfer the O&M transaction identifier.

In another preferred embodiment, each O&M transaction identifier comprises an O&M session identifier and an O&M action identifier, the O&M session identifier being generated when an O&M session is initiated, and the O&M action identifier being generated when an O&M action is initiated inside an O&M session, the O&M transaction identifier thus being generated when an O&M action is initiated.

In another preferred embodiment, the O&M transaction identifier consists of a node identification part comprising an IP-address, or a Fully Qualified Domain Name, an O&M session identification part comprising a running sequence number and an O&M action identification part comprising a O&M session specific running number.

Other preferred embodiments are disclosed in the dependent claims.

This aim is also achieved by means of a method according to the introduction, where further said method comprises the following steps when an O&M action is performed at a node in the O&M hierarchical layer structure, said O&M action being initiated inside an O&M session: generating an O&M transaction identifier; distributing the action in the form of a command to at least one other node in the O&M hierarchical layer structure; making the original O&M transaction identifier available as a corresponding O&M transaction identifier at said other node, the original O&M transaction identifier thus being available in all nodes, making it possible to trace the O&M activity throughout the O&M hierarchical layer structure.

In a preferred embodiment, an O&M transaction identifier is generated at any node where an O&M action is initiated and, when needed, said node transfers said O&M transaction identifier.

Other preferred embodiments are disclosed in the dependent claims.

Several advantages are achieved by means of the present invention, for example:
easy tracing and correlation of O&M user activities; and
securing vital information such as user id, time stamps for performed O&M actions etc.

### BRIEF DESCRIPTION OF THE DRAWINGS

The present invention will now be described more in detail with reference to the appended drawings, where

FIG. 1 schematically shows a management system architecture in a telecommunication network system;

FIG. 2 schematically shows a node with an O&M transaction identifier according to the present invention; and

FIG. 3 schematically shows an O&M action being initiated from an NMS and being “deployed” to an SNM and related network elements.

### DETAILED DESCRIPTION

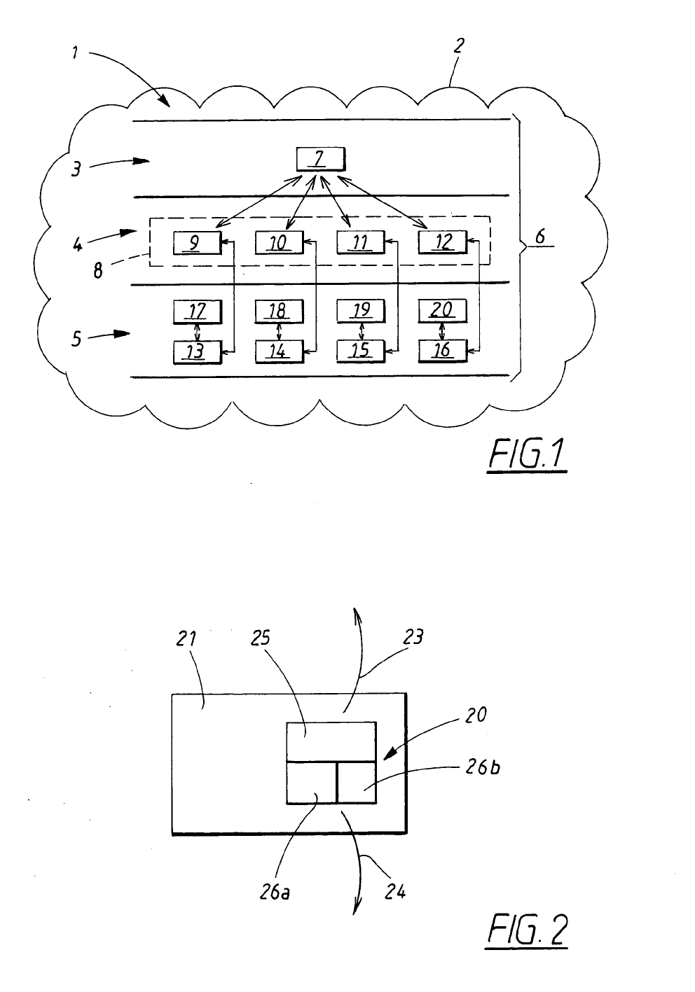

In FIG. 1, a management system architecture 1 intended for use in a 3G (third generation) telecommunication network system 2 is shown, said management system architecture 1 being divided into a number of 5 hierarchical layers. In FIG. 1, a top layer 3, a middle layer 4 and a bottom layer 5 is shown. The top layer 3 is a network management layer, the middle layer 4 is a sub network management layer and the bottom layer 5 is an element management layer. The layers 3, 4, 5 form an O&M hierarchical layer structure 6.

The network management layer 3 at least comprises a node of the type NMS (Network Management System) 7 which in turn comprises applications for specific aspects of all parts of the complete network system 2, for example fault handling. In this layer 3, management of the complete network system 2 is carried out. The network system 2 may additionally comprise several systems, for example both a 2G (second generation) and a 3G system.

The sub network management layer 4 at least comprises a node of the type SNM (Sub-network Management System) 8, which is arranged to support centralized O&M for a part of the complete network system, for example for a radio access network. The SNM 8 contains management applications for day-to-day handling of O&M functions, such as collection and evaluation of alarms and performance data.

Different SNM:s may be comprised in the sub network management layer 4, for example a first SNM 9 for a service layer (entities providing services to end-users and content & application providers), a second SNM 10 for IP Multimedia Systems (network architecture standardized by ETSI (European Telecommunications Standards Institute) for operators to provide IP based mobile and fixed multimedia services), a third SNM 11 for a core network (entities providing circuit-switched and packet switched services) and a fourth SNM 12 for a radio network (entities providing a radio access for wireless systems).

The NMS 7 and SNM 8 usually support open interfaces, such as 3GPP (₃rd Generation Partnership Project) IRP (Integration Reference Point) based on for example CORBA (Common Object Request Broker Architecture). The element management layer 5 manages individual nodes 13, 14, 15, 16, such as an RNC (Radio Network Controller), an SGSN (Switching GPRS Support Node), CSCF (Call Session Control Function) and various other network equipment such as routers and switches. The nodes are usually interfaced by means of corresponding node element managers 17, 18, 19, 20. A node element manager is an entity (typically a Windows or Unix client based GUI (General User Interface)) used to administer a node that encompasses O&M management functions.

According to the present invention, with reference to FIG. 2, when an O&M user initiates an O&M session, an O&M session identifier is generated. When an O&M action is initiated inside an O&M session, an O&M action identifier 20 is generated in the node 21, for example NMS or SNM. Together with a node identification, the O&M session identifier and the O&M action identifier constitute an O&M transaction identifier. For instance, the node identification can be a configurable string, such as “OSS-STOCKHOLM, “MSC33” or “GGSN_TELIASONERA”.

A user is preferably authenticated before an O&M transaction identifier is generated. When a user initiates a new O&M action, a new O&M action identifier is generated. When a user is referred to in this description, network operator O&M personnel or the like is meant, not a subscriber or the like.

The O&M transaction identifier is then transferred 23, 24 to all nodes in all management layers 3, 4, 5 used for said O&M action. The O&M transaction identifier 20 will be available in logs produced for performed O&M actions in concerned nodes, making it very easy to correlate information regarding the performed O&M actions afterwards.

Thus, any node 21 that performs authentication for a user can also generate an O&M transaction identifier 20. The O&M transaction identifier 20 should then be transferred to concerned nodes over used O&M interfaces, thus making it possible for other applications or nodes to use the O&M transaction identifier 20, preferably for logging purposes. This also makes it possible to correlate actions performed by a user even if no user identification information is transferred between applications or nodes.

The management applications, or nodes 7, 8, 9, 10, 11, 12, 13, 14, 15, 16, in all layers 3, 4, 5 are arranged to be able to generate an O&M transaction identifier 20, and all used O&M protocols and interfaces are adopted to transfer the O&M transaction identifier 20.

In a preferred embodiment of the present invention, the O&M transaction identifier 20 consists of three parts: a node identification part 25 comprising an IP-address or a Fully Qualified Domain Name, an O&M session identification part 26a comprising a running sequence number and an O&M action identification part 26b comprising a O&M session specific running number.

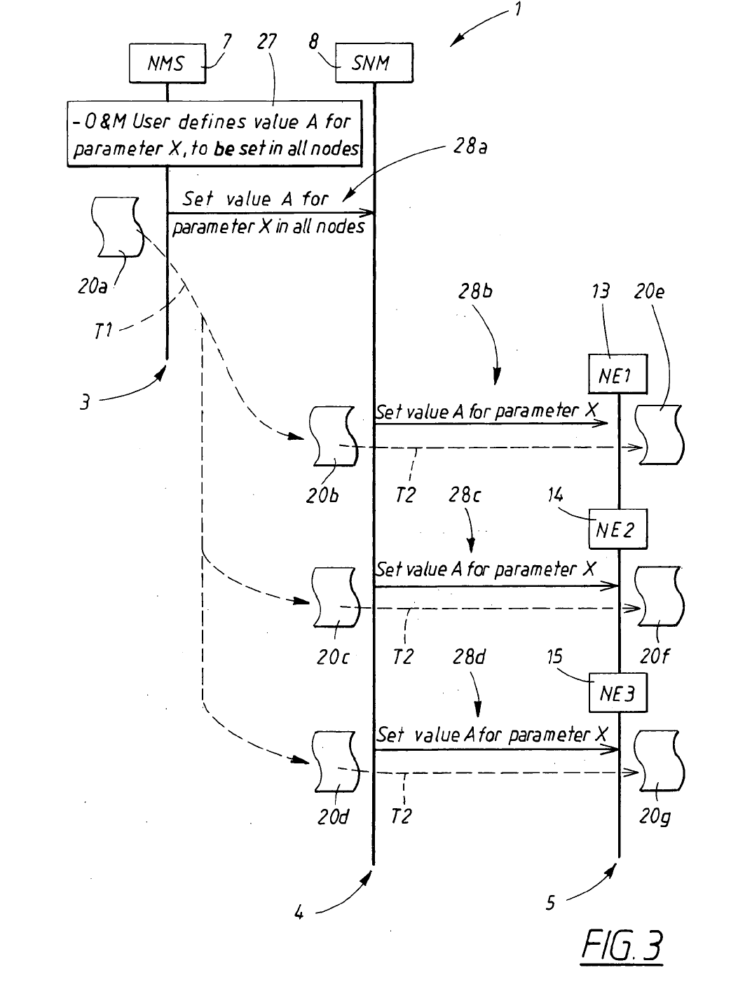

The usage of an O&M transaction identifier will now be described more in detail with reference to FIG. 3.

FIG. 3 illustrates an example where an O&M transaction identifier 20a-g is used for correlation of O&M transaction information. In the example, it is assumed that an O&M action 27 is performed at the NMS 7 in the network management layer 3, inside an O&M session. The action 27 is in the form of a user defining a value A for a parameter X to be set in all nodes. First, an O&M transaction identifier 20a is generated, comprising a session identifier and an action identifier. The NMS then 7 distributes the action 27 in the form of a command 28a to the SNM 8 in the sub network management layer 4. The SNM 8 then distributes the command 28b, 28c, 28d to individual network element nodes 13, 14, 15. The original O&M transaction identifier 20a is then transferred T1 to the SNM 8 and becomes available as O&M transaction identifiers 20b, 20c, 20d at the SNM 8, one O&M transaction identifier 20b, 20c, 20d for each distribution of the command 28b, 28c, 28d to the individual network element nodes 13, 14, 15. Furthermore, the original O&M transaction identifier 20a is transferred T2 to the individual network element nodes 13, 14, 15 and thus becomes available as O&M transaction identifiers 20e, 20f, 20g at the individual network element nodes 13, 14, 15 which received the respective command 28b, 28c, 28d.

The same O&M transaction identifier thus is available in all logs in all nodes 7, 8, 13, 14, 15 which makes it possible to trace an O&M activity 27 throughout the O&M network 1.

In the example above, the O&M action 27 can of course also be initiated from the SNM 8 instead. In general, an O&M action may be initiated in any node in the O&M hierarchical layer structure 6.

An example of an O&M action may be a configuration of network nodes such as for example an RNC. These actions can be performed in the network management layer 3, the sub-network management layer 4and/or the element management layer 5. The O&M action may then result in produced accountability information, for example in the form of logs in several management applications as a result of the action being executed.

In the example above, and generally, the O&M user is authenticated and authorized prior to being allowed to perform O&M actions. When the authentication has been performed, the O&M application node in question generates an O&M transaction identifier. When the O&M transaction identifier has been generated, it is transferred further in the protocols, for example CORBA, and interfaces used, together with information for the performed O&M actions.

If needed, all applications processing said information for generating logs, or for other purposes, uses the provided O&M transaction identifier.

Afterwards, when data is processed in various post-processing systems for accountability purposes, it is possible to correlate and trace activities performed by a certain user at a certain time.

The communication between the nodes in the example above takes place using so-called IRP:s (Integration Reference Point). IRP:s have been developed to promote a wider adoption of standardized Management interfaces in telecommunication networks. The IRP methodology employs Protocol & Technology Neutral modelling methods as well as protocol specific solution sets to help achieve its goals.

3GPP has standardized a number of IRP:s for O&M communication between management systems and network elements. In the O&M architecture according to a preferred embodiment, IRP:s are used both for internal and external communication. This communication may be directed towards other network operator's equipment. Thus, solutions provided for any IRP:s may be adopted to certain specialized varieties.*

The present invention is not limited to the examples described above, but may be varied freely within the scope of the appended claims. For example, other layer configurations may be possible, the core of the invention is to generate an O&M transaction identifier 20 in the node 21 where an O&M action is initiated. The O&M transaction identifier 20 is then transferred 23, 24 to all nodes in all management layers 3, 4, 5 used for said O&M action.

The node 21 where an O&M action is initiated may be any node in an O&M hierarchical layer structure 6.

The invention is applicable to all telecommunication systems that have any type of O&M architecture, both wireless as well as wired.

The O&M transaction identifier 20 may consist of more or less then said three parts, examples of other parts is for example a date, time stamp or operator specific information.

It is also possible that the O&M session identification part 26a, comprising a running sequence number, and the O&M action identification part 26b, comprising an O&M session specific running number, are combined to one part, comprising only one running number.

What is claimed is:

1.-18. (canceled)

19. A telecommunication system, comprising:
an Operation and Maintenance (O&M) hierarchical layer structure comprising at least two O&M nodes in at least two hierarchical layers, where O&M actions may be initiated at said nodes, wherein the system is arranged for generation of an O&M transaction identifier, which O&M transaction identifier is generated when an O&M action is initiated, and is transferred to all nodes in all management layers used for said O&M action, said O&M action being initiated inside an O&M session, allowing O&M actions and sessions to be tracked in the O&M hierarchical layer structure.

20. The telecommunication system according to claim 19, wherein the hierarchical layers comprise a network management layer, a sub network management layer and an element management layer, the layers forming an O&M hierarchical layer structure.

21. The telecommunication system according to claim 20, wherein the network management layer at least comprises a node of the type Network Management System (NMS), the sub network management layer at least comprises a node of the type Sub-network Management System (SMS) and that the element management layer manages individual nodes which are interfaced by means of corresponding node element managers.

22. The telecommunication system according to claim 19 wherein, in any node where an O&M action is initiated, said node is arranged to generate an O&M transaction identifier and, when needed, to transfer the O&M transaction identifier.

23. The telecommunication system according to claim 22, wherein said O&M transaction identifier is generated when the initiating user is authenticated.

24. The telecommunication system according to claim 19, wherein each O&M transaction identifier comprises an O&M session identifier and an O&M action identifier, the O&M session identifier being generated when an O&M session is initiated, and the O&M action identifier being generated when an O&M action is initiated inside an O&M session, the O&M transaction identifier thus being generated when an O&M action is initiated.

25. The telecommunication system according to claim 19, wherein the O&M transaction identifier consists of a node identification part comprising an IP-address, or a Fully Qualified Domain Name, and a running number.

26. The telecommunication system according to claim 19, wherein the O&M transaction identifier comprises a node identification part further comprising an IP-address, or a Fully Qualified Domain Name; an O&M session identification part comprising a running sequence number; and an O&M action identification part comprising a O&M session specific running number.

27. The telecommunication system according to claim 19, wherein the telecommunication system is a 3GPP based mobile telecommunication system.

28. The telecommunication system according to claim 27, wherein the telecommunication system is Wide Code Division Multiple Access (WCDMA).

29. The telecommunication system according to claim 19, wherein the telecommunication system is a wired system.

30. The telecommunication system according to claim 19, wherein all O&M actions are initiated by O&M users, which users are authenticated and authorized prior to being allowed to perform O&M actions.

31. The telecommunication system according to claim 19, wherein Integration Reference Point (IRPs) are arranged for handling the communication between the nodes.

32. A method for tracking Operation and Maintenance (O&M) actions in an O&M hierarchical layer structure, comprising the steps of:
performing an O&M action at a node in the O&M hierarchical layer structure, said O&M action being initiated inside an O&M session;
generating an O&M transaction identifier;
distributing the action in the form of a command to at least one other node in the O&M hierarchical layer structure;
making the original O&M transaction identifier available as a corresponding O&M transaction identifier at said other node, the original O&M transaction identifier thus being available in all nodes, making it possible to trace the O&M activity throughout the O&M hierarchical layer structure.

33. The method according to claim 32, wherein the O&M transaction identifier is generated at any node where an O&M action is initiated and, when needed, said node transfers said O&M transaction identifier.

34. The method according to claim 32, wherein the O&M transaction identifier is generated when the initiating user is authenticated.

35. The method to claim 32, wherein all O&M actions are initiated by O&M users, which users are authenticated and authorized prior to being allowed to perform O&M actions.

36. The method according to claim 32, wherein the communication between the nodes uses Integration Reference Points (IRPs).
